(19) United States
(12) Patent Application Publication
(10) Pub. No.: US 2023/0386450 A1
(43) Pub. Date: Nov. 30, 2023

(54) SYSTEM AND METHOD FOR DETECTING UNHANDLED APPLICATIONS IN CONTRASTIVE SIAMESE NETWORK TRAINING

(71) Applicant: Samsung Electronics Co., Ltd., Suwon-si (KR)

(72) Inventors: Brendon Christopher Beachy Eby, Chicago, IL (US); Suhel Jaber, San Jose, CA (US); Sai Ajay Modukuri, San Francisco, CA (US); Omar Abdelwahab, Mountain View, CA (US); Ankit Goyal, Belmont, CA (US)

(21) Appl. No.: 18/303,394

(22) Filed: Apr. 19, 2023

Related U.S. Application Data
(60) Provisional application No. 63/345,614, filed on May 25, 2022.

(51) Int. Cl. G10L 15/06; G10L 15/183

(52) U.S. Cl. CPC G10L 15/063; G10L 2015/0636; G10L 15/183

(57) ABSTRACT

A method includes determining, using at least one processing device of an electronic device, a target embedding vector for each class of a plurality of classes. The method also includes generating, using the at least one processing device, an utterance embedding vector using a pre-trained language model, where the utterance embedding vector represents an input utterance associated with an expected class. The method further includes obtaining, using the at least one processing device, a predicted class associated with the input utterance based on distances of the utterance embedding vector to spatial parameters representing the plurality of classes, where the spatial parameter of each class is based on the target embedding vector associated with that class. In addition, the method includes updating, using the at least one processing device, parameters of the language model based on a difference between the predicted class and the expected class.

### CROSS-REFERENCE TO RELATED APPLICATION AND PRIORITY CLAIM

This application claims priority under 35 U.S.C. § 119(e) to U.S. Provisional Patent Application No. 63/345,614 filed on May 25, 2022, which is hereby incorporated by reference in its entirety.

### TECHNICAL FIELD

This disclosure relates generally to natural language processing systems. More specifically, this disclosure relates to a system and method for detecting unhandled applications in contrastive Siamese network training.

### BACKGROUND

Siamese network training can be very effective for similarity-based machine learning tasks. Siamese network training can involve training multiple networks to place phrases relative to each other, rather than relative to an embedding space directly. For example, to determine the similarity between two phrases, an output embedding from a pretrained Large Language Model (LLM) such as BERT for each phrase can be calculated independently, and their similarity can be determined based on the “closeness” of the outputs using a distance metric (such as negative Euclidian distance or cosine similarity). This differs from standard classification methods in which the output of a pretrained LLM is used directly for classification. Training in this way allows a network to learn both the output embedding of an input phrase and the target's embedding simultaneously, giving it an enhanced ability to learn complex relationships.

### SUMMARY

This disclosure provides a system and method for detecting unhandled applications in contrastive Siamese network training.

In a first embodiment, a method includes determining, using at least one processing device of an electronic device, a target embedding vector for each class of a plurality of classes. The method also includes generating, using the at least one processing device, an utterance embedding vector using a pre-trained language model, where the utterance embedding vector represents an input utterance associated with an expected class. The method further includes obtaining, using the at least one processing device, a predicted class associated with the input utterance based on distances of the utterance embedding vector to spatial parameters representing the plurality of classes, where the spatial parameter of each class is based on the target embedding vector associated with that class. In addition, the method includes updating, using the at least one processing device, parameters of the language model based on a difference between the predicted class and the expected class.

In a second embodiment, an electronic device includes at least one processing device configured to determine a target embedding vector for each class of a plurality of classes. The at least one processing device is also configured to generate an utterance embedding vector using a pre-trained language model, where the utterance embedding vector represents an input utterance associated with an expected class. The at least one processing device is further configured to obtain a predicted class associated with the input utterance based on distances of the utterance embedding vector to spatial parameters representing the plurality of classes, where the spatial parameter of each class is based on the target embedding vector associated with that class. In addition, the at least one processing device is configured to update parameters of the language model based on a difference between the predicted class and the expected class.

In a third embodiment, a non-transitory machine-readable medium contains instructions that when executed cause at least one processor of an electronic device to determine a target embedding vector for each class of a plurality of classes. The medium also contains instructions that when executed cause the at least one processor to generate an utterance embedding vector using a pre-trained language model, where the utterance embedding vector represents an input utterance associated with an expected class. The medium further contains instructions that when executed cause the at least one processor to obtain a predicted class associated with the input utterance based on distances of the utterance embedding vector to spatial parameters representing the plurality of classes, where the spatial parameter of each class is based on the target embedding vector associated with that class. In addition, the medium contains instructions that when executed cause the at least one processor to update parameters of the language model based on a difference between the predicted class and the expected class.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart. home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component.” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for detecting unhandled applications in contrastive Siamese network training according to this disclosure;

FIG. 3 illustrates example classes and example threshold boundaries that can be used during distance calculation in the process of FIG. 2 according to this disclosure;

FIG. 4 illustrates an example distance measurement from a class threshold boundary according to this disclosure;

FIG. 5 illustrates an example distance measurement from a class target according to this disclosure;

FIG. 6 illustrates an example n-dimensional space in which an input utterance can be mapped according to this disclosure; and

FIG. 7 illustrates an example method for detecting unhandled applications in contrastive Siamese network training according to this disclosure.

### DETAILED DESCRIPTION

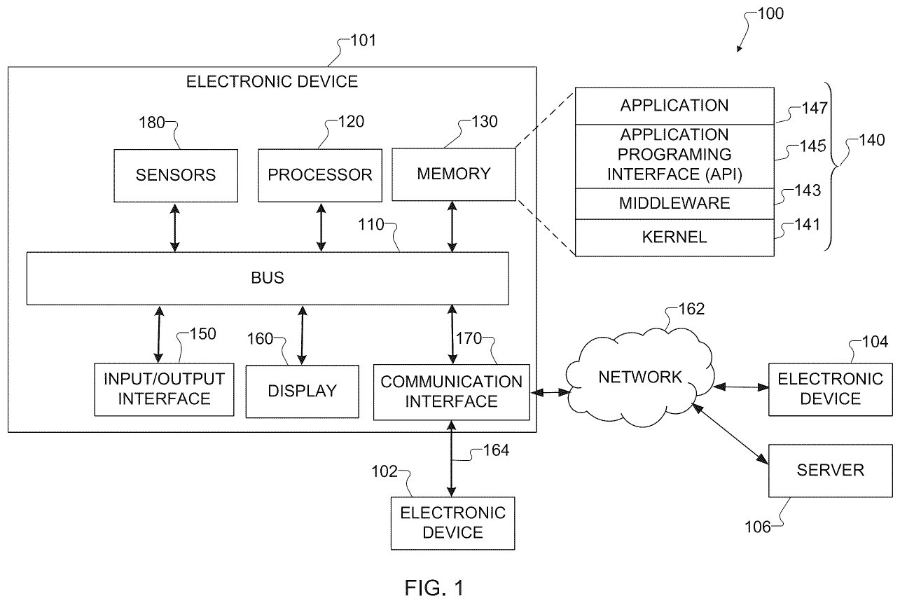

FIGS. 1 through 7, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, Siamese network training can be very effective for similarity-based machine learning tasks. Siamese network training can involve training multiple networks to place phrases relative to each other, rather than relative to an embedding space directly. For example, to determine the similarity between two phrases, an output embedding from a pretrained Large Language Model (LLM) such as BERT for each phrase can be calculated independently, and their similarity can be determined based on the “closeness” of the outputs using a distance metric (such as negative Euclidian distance or cosine similarity). This differs from standard classification methods in which the output of a pretrained LLM is used directly for classification. Training in this way allows a network to learn both the output embedding of an input phrase and the target's embedding simultaneously, giving it an enhanced ability to learn complex relationships.

Many applications include examples that lie outside the boundaries of a given classes, which can be referred to as “out-of-domain” or “unhandled” examples. Being able to effectively flag those examples can be important to the overall performance of a language model, which in some cases may be particularly important or useful for dialogue or other systems. However, this can be a challenge since those unhandled cases may vary greatly and may not follow similarity patterns like a standard class. This creates issues such as (i) what to select as the targets from which utterance distances will be calculated and (ii) given that unhandled examples can vary widely, how to detect the examples without adding “unhandled” as a separate label.

This disclosure provides various techniques for detecting unhandled applications in contrastive Siamese network training. As described in more detail below, the disclosed systems and methods utilize Siamese networks when training utterance classification tasks while also being able to label unhandled examples effectively. In some embodiments, the disclosed systems and methods determine a target embedding vector for each class of training data and generate an utterance embedding vector using a language model, where the utterance embedding vector represents an input utterance associated with an expected class. The disclosed systems and methods also obtain a predicted class associated with the input utterance and update parameters of the language model based on a difference between the predicted class and the expected class.

Note that while some of the embodiments discussed below are described in the context of use in a computing device such as a server, this is merely one example, and it will be understood that the principles of this disclosure may be implemented in any number of other suitable contexts and may use any suitable devices. For example, some embodiments could be implemented on personal computers, smartphones, tablet computers, smart watches or other wearable devices, smart devices, and the like.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform one or more operations for detecting unhandled applications in contrastive Siamese network training.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for detecting unhandled applications in contrastive Siamese network training as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (OLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for detecting unhandled applications in contrastive Siamese network training.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

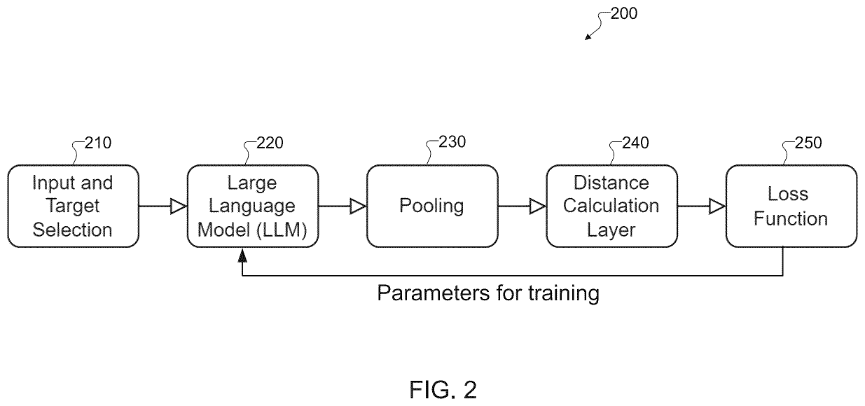

FIG. 2 illustrates an example process 200 for detecting unhandled applications in contrastive Siamese network training according to this disclosure. For ease of explanation, the process 200 is described as being performed using one or more components of the network configuration 100 of FIG. 1, such as the server 106. However, this is merely one example, and the process 200 could be performed using any other suitable device(s) and in any other suitable system(s).

As shown in FIG. 2, the server 106 performs a selection operation 210. During the selection operation 210, the server 106 selects an input utterance that could represent a sentence or utterance including one or more words (represented as tokens in the input utterance). In some embodiments, the input utterance is an utterance that is selected for use in Siamese network training. The server 106 also selects one or more target embedding vectors for each class among multiple classes of training utterances. From the target embedding vectors, the similarity to the input utterance will be calculated. In some embodiments, the training utterances are part of a training set of historical utterances labeled with one or more classes. Also, in some embodiments, the server 106 passes each training utterance in the training set through a pre-trained language model (such as a large language model 220 described in greater detail below), groups the training utterances into clusters by class, and calculates either the mean or median embedding vector of each class.

Once the server 106 obtains the mean or median embedding vector for each class, the server 106 selects the target embedding vectors for each class. The server 106 can select the target embedding vectors using any of several different techniques. For example, in some embodiments, the server 106 selects the mean or median embedding vector of a class as a fixed target embedding vector for that class. In other embodiments, the server 106 selects the mean or median embedding vector of a class as an initial learnable target embedding vector for that class, which can be subsequently fine-tuned during training. In still other embodiments, the server 106 selects an utterance as a representative target for each class, such as the utterance determined to be the example closest to either the mean or median embedding vector of that class. These selected class embedding vectors represent the “centroid” or “target” for each class and thus are referred to as the “class centroid” or “class target.”

Once the target embedding vectors are selected, the server 106 passes the tokens of the input utterance through the large language model (LLM) 220. The LLM 220 generates token embedding vectors based on the tokens of the input utterance and outputs the token embedding vectors. In some embodiments, the LLM 220 generates a token embedding vector for each word of the input utterance. The LLM 220 can represent any suitable large pre-trained language model that outputs an embedding vector for every input token, such as a BERT model.

The token embedding vectors generated by the LLM 220 are used by the server 106 to perform a pooling operation 230 in a pooling layer. In the pooling operation 230, the server 106 combines or “pools” the token embedding vectors from the LLM 220 into a single utterance embedding vector, which is an overall representation of the input utterance. The server 106 can combine the token embedding vectors using any of several different techniques. In some embodiments, the server 106 can calculate a simple average of the token embedding vectors for the tokens. In other embodiments, the server 106 can calculate a weighted average of the token embedding vectors for the tokens, where the weights are calculated using a learnable attention layer and where the query token used with that attention layer may be the CLS (class) token for the input utterance. In still other embodiments, the server 106 can combine the token embedding vectors using a LogAvgExp function, which may be defined as:

LogAvgExp(inputs,α)=Log(Avg(Exp(inputs*α)))/α (1)

Here, α is a hyperparameter that can be used to smoothly select a point between the maximum of the inputs when α→∞ or a mean of the inputs when α→0. In yet other embodiments, using a modification of Equation (1), the value of α may be a learnable parameter that can be optimized during training. Depending on the implementation, the value of α may be a single value to be used for all input dimensions, or α may represent a vector with a different learnable value per input dimension.

Based on the pooling operation 230, the utterance embedding vector has been determined for the given input utterance and for all class targets. The server 106 executes a distance calculation layer 240, which determines how similar the input utterance is to each class of training utterances. If the input utterance is not similar to any class of training utterances, the input utterance can be considered to be “unhandled.” Accordingly, in the distance calculation layer 240, the server 106 can determine a similarity of the input utterance to each class label, as well as its similarity to an unhandled classification. The similarity can be based on a calculated “distance” between the utterance embedding vector and a selected spatial parameter representing each class. The distance between the utterance embedding vector and the selected spatial parameter can be calculated using any suitable distance metric, such as negative Euclidian distance or cosine similarity. Depending on the embodiment, the selected spatial parameter can be a threshold boundary of the class or the class target of the class.

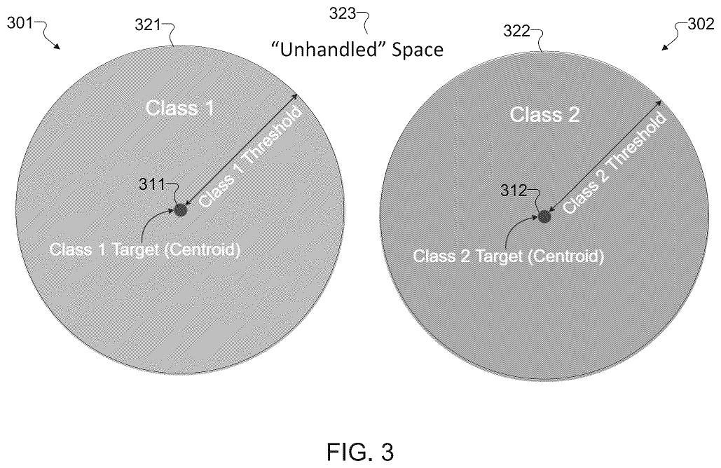

In some embodiments, the distance calculation layer 240 can determine a threshold boundary for each class. A threshold boundary represents a hyper-spherical boundary between a given class and “unhandled” space. As discussed in greater detail below, the threshold boundaries can be learnable during the training process. FIG. 3 illustrates example classes and example threshold boundaries that can be used during distance calculation in the process 200 of FIG. 2 according to this disclosure. As shown in FIG. 3, two classes, namely a class 301 (“Class 1”) and a class 302 (“Class 2”), represent a subset of the classes of training utterances that are selected during the selection operation 210. Each class 301 and 302 is respectively represented by a corresponding class centroid or class target 311 and 312, which is the class embedding vector for that class. Each class 301 and 302 also has a threshold boundary 321 and 322, which respectively represent the hyper-spherical boundary between the class 301 and 302 and an “unhandled” space 323. In general, the embeddings of utterances from a particular class 301 and 302 will be clustered around each class target 311 and 312 within the threshold boundary 321 and 322, and “unhandled” utterances will be located in the “unhandled” space 323 between and around the threshold boundaries 321 and 322.

With respect to the distance from a threshold boundary, the similarity of an input utterance to a particular class label can be based on a calculated distance between the utterance embedding vector and the threshold boundary of that class. In some embodiments, the similarity of the input utterance to the class can be calculated as follows:

=distance_{i,t}=distance_to_centroid_{i,t}+thresholdₜ (2)

Here, similarity_{i,t} is the similarity score of an input utterance i relative to the class target t of the class, distance_to_centroid_{i,t} is the distance from the input utterance i to the class target t, and thresholdₜ is the distance from the target t to the threshold boundary for that class. For these embodiments, an “unhandled” class may be assigned a similarity score of zero.

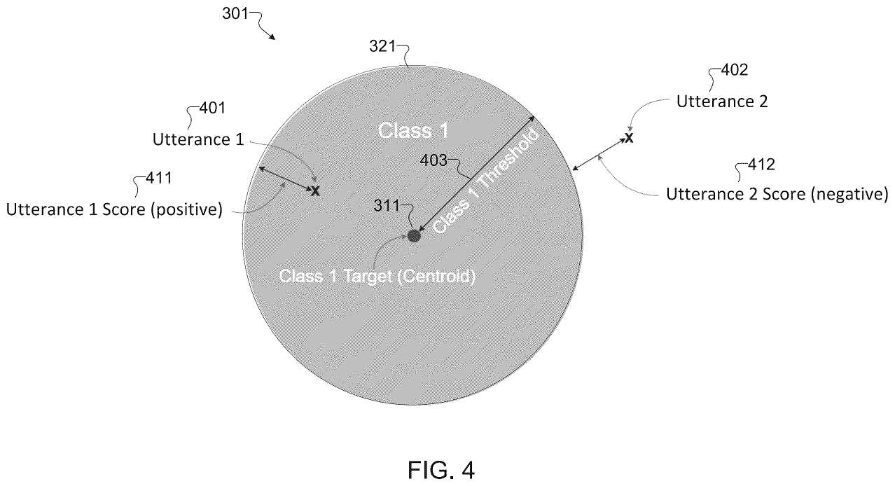

FIG. 4 illustrates an example distance measurement from a class threshold boundary according to this disclosure. As shown in FIG. 4, two input utterances, namely an utterance 401 (“Utterance 1”) and an utterance 402 (“Utterance 2”), are compared to the class 301 in order to determine the similarities of the utterances 401 and 402 to the class 301. The similarity score 411 and 422 for each utterance 401 and 402 is based on the distance between each utterance 401 and 402 and the threshold boundary 321 for the class 301. This distance can be calculated as shown in Equation (2), where distance_to_centroid is the distance from the utterance 401 and 402 to the class target 311 and where threshold is the distance from the class target 311 to the threshold boundary 321, which is indicated by the distance 403.

Note that the value of distance_to_centroid may be a negative value and that the value of threshold may be a positive value. Thus, the similarity scores can be positive for an input utterance inside a class's threshold boundary (such as the utterance 401) and negative for an input utterance outside a class's threshold boundary (such as the utterance 402). This means that, if all similarity scores are outside their thresholds, the unhandled score of zero will be the highest score for that input utterance, leading to an “unhandled” classification. In these embodiments, training may be performed by cross-entropy, with a single positive class for each utterance and the remainder negative.

With respect to distance from a class target, the similarity score of an input utterance to a particular class label may be set as the measured distance from the input utterance to the class target of that class (such as distance_to_centroid) without any modification. In some embodiments, the similarity of an input utterance to the “unhandled” label may be calculated as follows:

similarity_unhandledᵢ=

−1*smooth_max({(distance_to_centroid_{i,t}+thresholdₜ) for t in T}) (3)

Here, distance_to_centroid_{i,t} is the distance from the input utterance i to the class target t, thresholdₜ is the distance from the target t to the threshold boundary for that class, T is the set of all class targets (centroids), and “smooth_max” is a function such as LogSumExp that calculates a smooth maximum of the thresholded distances to each class target. In these embodiments, training may be done by cross entropy, with a single positive class for each utterance and the remainder negative.

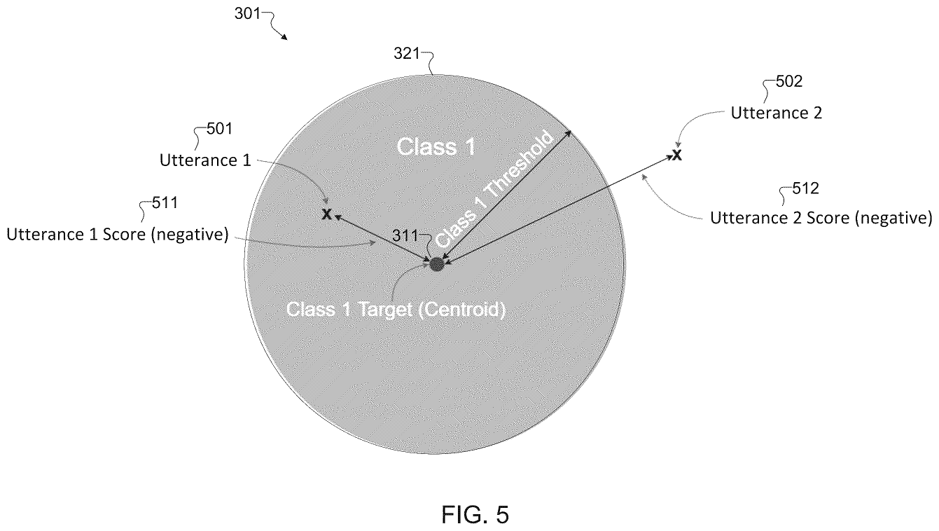

FIG. 5 illustrates an example distance measurement from a class target according to this disclosure. As shown in FIG. 5, two input utterances, namely an utterance 501 (“Utterance 1”) and an utterance 502 (“Utterance 2”), are compared to the class 301 in order to determine the similarities of the utterances 501 and 502 to the class 301. The similarity score 511 and 512 for each utterance 501 and 502 is based on the distance between each utterance 501 and 502 and the class target 311 for the class 301. This distance is represented as distance_to_centroid and may be a negative value. Thus, the similarity scores may be negative.

Turning again to FIG. 2, once the similarities of the input utterance to each class of training utterances have been determined by the distance calculation layer 240, the server 106 predicts the class of the input utterance. If there is no similarity between the input utterance and one of the target classes, the server 106 can predict an “unhandled” class for the input utterance. The prediction can be passed to a loss function 250, which the server 106 uses to calculate the error of the model, and back-propagated for training. For example, the input utterance can be associated with an expected class, and the loss function 250 can be based on the difference between the expected class and the predicted class. As discussed above, in some embodiments, the loss function 250 can be based on cross entropy. However, this is merely one example, and the loss function 250 can represent any suitable loss function for use in training a language model.

In some embodiments, training may be split into two distinct stages. For example, in the first stage, one or more examples of unhandled training utterances may be separated from the training dataset into an “unhandled” class dataset. For each batch of training data, a sample of n unhandled utterances may be selected from the unhandled dataset and may be added as negative targets for cross entropy training in addition to class targets. In this way, the model learns to push unhandled examples further away from the class targets (centroids) while continuing to pull class examples toward those class targets. In the second stage, the LLM 220 may be frozen, and similarity training may continue, such as by using the distance from threshold boundary or distance from target techniques described above. In some cases, during the second stage, the LLM 220 may be frozen, a dense classification layer may be added to the output, and the dense classification layer may be trained for classification purposes.

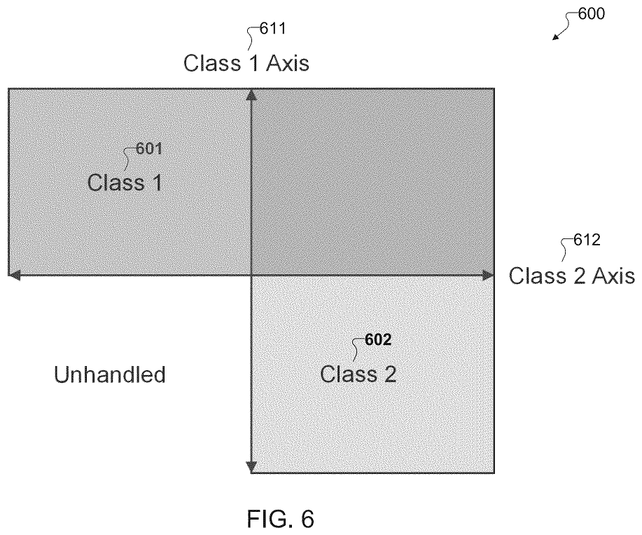

Also, in some embodiments, the output from the LLM 220 can be mapped with a linear layer to a single output dimension (logit) for each class. For example, if a logit has a positive value, the given input utterance may be a member of the class associated with that logit. If a logit has a negative value, the given input utterance may not be a member of the class associated with that logit. An “unhandled” label would be assigned when the logits have negative values for all classes. One example of this is shown in FIG. 6.

FIG. 6 illustrates an example n-dimensional space 600 in which an input utterance can be mapped according to this disclosure. As shown in FIG. 6, this example of the n-dimensional space 600 represents a two-dimensional space (n=2) for two classes, namely a class 601 (“Class 1”) and a class 602 (“Class 2”). Note that this is for ease of illustration only. In typical implementations, n may be greater than two and perhaps be much greater than two. Each class 601 and 602 has a corresponding axis 611 and 612, which divides the class 601 and 602 into positive and negative spaces. If a logit for an input utterance falls to the right of the Class 1 axis 611, the logit has a positive value for that dimension, and the input utterance is a member of Class 1. If the logit for the input utterance falls to the left of the Class 1 axis 611, the logit has a negative value for that dimension, and the input utterance is not a member of Class 1. Similarly, if the logit for the input utterance falls above the Class 2 axis 612, the logit has a positive value for that dimension, and the input utterance is a member of Class 2. If the logit for the input utterance falls below the Class 2 axis 612, the logit has a negative value for that dimension, and the input utterance is not a member of Class 2. If the logit for the input utterance is both to the left of the Class 1 axis 611 and below the Class 2 axis 612, the logit is not a member of either Class 1 or Class 2 and is considered “unhandled.” During training, the logit for the “unhandled” logit may be equal to:

−1*LogSumExp(logits*α)/α, (4)

where α is a hyperparameter. This allows for differentiable training of unhandled inputs.

Although FIG. 2 through 6 illustrate one example of a process 200 for detecting unhandled applications in contrastive Siamese network training and related details, various changes may be made to FIGS. 2 through 6. For example, while described as involving a specific sequence of operations, various operations of the techniques described with respect to FIGS. 2 through 6 could overlap, occur in parallel, occur in a different order, or occur any number of times (including zero times). Also, the specific operations shown in FIGS. 2 through 6 are examples only, and other techniques could be used to perform each of the operations shown in FIGS. 2 through 6.

Note that the operations and functions shown in or described with respect to FIGS. 2 through 6 can be implemented in an electronic device 101, 102, 104, server 106, or other device(s) in any suitable manner. For example, in some embodiments, the operations and functions shown in or described with respect to FIGS. 2 through 6 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 6 can be implemented or supported using dedicated hardware components. In general, the operations and functions shown in or described with respect to FIGS. 2 through 6 can be performed using any suitable hardware or any suitable combination of hardware and software/firmware instructions.

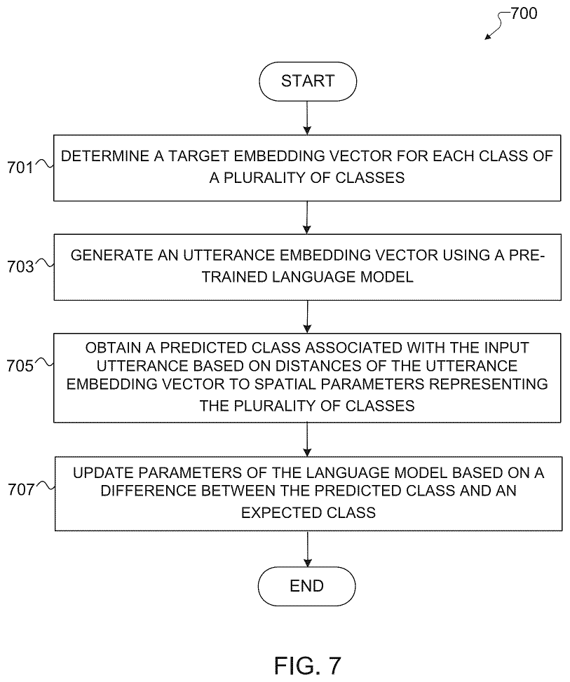

FIG. 7 illustrates an example method 700 for detecting unhandled applications in contrastive Siamese network training according to this disclosure. For ease of explanation, the method 700 shown in FIG. 7 is described as involving the use of the process 200 shown in FIG. 2 and the electronic device 101 shown in FIG. 1. However, the method 700 shown in FIG. 7 could be used with any other suitable process(es) and device(s).

As shown in FIG. 7, a target embedding vector is determined for each class of a plurality of classes at step 701. This could include, for example, the electronic device 101 performing the selection operation 210 to select the target embedding vectors for each class of training utterances. An utterance embedding vector is generated using a pre-trained language model at step 703. This could include, for example, the electronic device 101 performing the selection process 210 to select the input utterance and passing the input utterance through the LLM 220 and the pooling operation 230 to generate the utterance embedding vector. The utterance embedding vector represents an input utterance associated with an expected class.

A predicted class associated with the input utterance is obtained at step 705. This could include, for example, the electronic device 101 executing the distance calculation layer 240 to obtain the predicted class of the input utterance. The predicted class is obtained based on distances of the utterance embedding vector to spatial parameters representing the plurality of classes, where the spatial parameter of each class is based on the target embedding vector associated with that class. In some embodiments, the electronic device 101 could use the distance from threshold boundary technique, the distance from target technique, or any other suitable technique while executing the distance calculation layer 240. In some embodiments, the distance of the utterance embedding vector to the spatial parameter of a specified one of the plurality of classes comprises a distance of the utterance embedding vector to a threshold boundary of the specified class, where the threshold boundary represents a boundary between the specified class and an unhandled space. One or more parameters of the language model are updated based on a difference between the predicted class and the expected class at step 707. This could include, for example, the electronic device 101 using the loss function 250 to update one or more parameters of the LLM 220 during training.

Although FIG. 7 illustrates one example of a method 700 for detecting unhandled applications in contrastive Siamese network training, various changes may be made to FIG. 7. For example, while shown as a series of steps, various steps in FIG. 7 could overlap, occur in parallel, occur in a different order, or occur any number of times.

Note that the various embodiments of this disclosure can be applied in a variety of use cases, such as with implementations of personal digital assistants. For example, experimental results show that the disclosed embodiments effectively classify incoming user utterances and direct the utterances to correct categories for downstream processing. The disclosed embodiments also effectively label utterances as “unhandled” when they are not a member of a known class, which can be useful or important. Among other things, false wake-ups, unsupported intents, and mistaken transcriptions are common in natural language systems and can be labeled as “unhandled” so that users receive consistent user experiences.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
determining, using at least one processing device of an electronic device, a target embedding vector for each class of a plurality of classes;
generating, using the at least one processing device, an utterance embedding vector using a pre-trained language model, the utterance embedding vector representing an input utterance associated with an expected class;
obtaining, using the at least one processing device, a predicted class associated with the input utterance based on distances of the utterance embedding vector to spatial parameters representing the plurality of classes, wherein the spatial parameter of each class is based on the target embedding vector associated with that class; and
updating, using the at least one processing device, parameters of the language model based on a difference between the predicted class and the expected class.

2. The method of Claim 1, wherein determining the target embedding vector for each class comprises:
obtaining training data comprising a plurality of historical embedding vectors representing historical utterances labeled with one or more classes; and
for each class of the plurality of classes, (i) determining a mean or a median of embedding vectors in that class and (ii) identifying one of the historical embedding vectors closest to the mean or the median as the target embedding vector for that class.

3. The method of claim 1, wherein:
the distance of the utterance embedding vector to the spatial parameter of a specified one of the plurality of classes comprises a distance of the utterance embedding vector to a threshold boundary of the specified class;
a positive value of the distance corresponds to the utterance embedding vector being inside the threshold boundary; and
a negative value of the distance corresponds to the utterance embedding vector being outside the threshold boundary.

4. The method of claim 1, wherein:
the distance of the utterance embedding vector to the spatial parameter of a specified one of the plurality of classes comprises a distance of the utterance embedding vector to a class target of the specified class; and
the distance of an utterance embedding to an unhandled class comprises a smooth negative maximum of distances from the utterance embedding vector to the class targets of the plurality of classes.

5. The method of claim 4, wherein the smooth negative maximum of distances is calculated using a trainable vector.

6. The method of claim 1, wherein:
the utterance embedding vector for the input utterance is mapped to a number of dimensions equal to the number of classes, each dimension representing a single class;
a positive value of a specified dimension indicates a positive label for the corresponding class; and
negative values of all dimensions representing the plurality of classes indicate an unhand led label.

7. The method of claim 1, wherein generating the utterance embedding vector using the pre-trained language model comprises:
inputting the input utterance to the language model, the input utterance comprising multiple tokens;
outputting, by the language model, a token embedding vector for each of the tokens of the input utterance; and
pooling the token embedding vectors to generate the utterance embedding vector.

8. The method of claim 1, wherein:
the target embedding vectors include multiple training utterances representing an unhandled class; and
the predicted class associated with the input utterance is obtained based on distances of the utterance embedding vector to (i) the spatial parameters representing the plurality of classes and (ii) additional spatial parameters representing the unhandled class.

9. An electronic device comprising:
at least one processing device configured to:
determine a target embedding vector for each class of a plurality of classes;
generate an utterance embedding vector using a pre-trained language model, the utterance embedding vector representing an input utterance associated with an expected class;
obtain a predicted class associated with the input utterance based on distances of the utterance embedding vector to spatial parameters representing the plurality of classes, wherein the spatial parameter of each class is based on the target embedding vector associated with that class; and
update parameters of the language model based on a difference between the predicted class and the expected class.

10. The electronic device of claim 9, wherein, to determine the target embedding vector for each class, the at least one processing device is configured to:
obtain training data comprising a plurality of historical embedding vectors representing historical utterances labeled with one or more classes; and
for each class of the plurality of classes, (i) determine a mean or a median of embedding vectors in that class and (ii) identify one of the historical embedding vectors closest to the mean or the median as the target embedding vector for that class.

11. The electronic device of claim 9, wherein:
the distance of the utterance embedding vector to the spatial parameter of a specified one of the plurality of classes comprises a distance of the utterance embedding vector to a threshold boundary of the specified class;
a positive value of the distance corresponds to the utterance embedding vector being inside the threshold boundary; and
a negative value of the distance corresponds to the utterance embedding vector being outside the threshold boundary.

12. The electronic device of claim 9, wherein:
the distance of the utterance embedding vector to the spatial parameter of a specified one of the plurality of classes comprises a distance of the utterance embedding vector to a class target of the specified class; and
the distance of an utterance embedding to an unhandled class comprises a smooth negative maximum of distances from the utterance embedding vector to the class targets of the plurality of classes.

13. The electronic device of claim 12, wherein the smooth negative maximum of distances is calculated using a trainable vector.

14. The electronic device of claim 9, wherein:
the utterance embedding vector for the input utterance is mapped to a number of dimensions equal to the number of classes, each dimension representing a single class;
a positive value of a specified dimension indicates a positive label for the corresponding class; and
negative values of all dimensions representing the plurality of classes indicate an unhandled label.

15. The electronic device of claim 9, wherein, to generate the utterance embedding vector using the pre-trained language model, the at least one processing device is configured to:
input the input utterance to the language model, the input utterance comprising multiple tokens;
output, by the language model, a token embedding vector for each of the tokens of the input utterance; and
pool the token embedding vectors to generate the utterance embedding vector.

16. The electronic device of claim 9, wherein:
the target embedding vectors include multiple training utterances representing an unhandled class; and
the at least one processing device is configured to obtain the predicted class associated with the input utterance based on distances of the utterance embedding vector to (i) the spatial parameters representing the plurality of classes and (ii) additional spatial parameters representing the unhandled class.

17. A non-transitory machine-readable medium containing instructions that when executed cause at least one processor of an electronic device to:
determine a target embedding vector for each class of a plurality of classes;
generate an utterance embedding vector using a pre-trained language model, the utterance embedding vector representing an input utterance associated with an expected class;
obtain a predicted class associated with the input utterance based on distances of the utterance embedding vector to spatial parameters representing the plurality of classes, wherein the spatial parameter of each class is based on the target embedding vector associated with that class; and
update parameters of the language model based on a difference between the predicted class and the expected class.

18. The non-transitory machine-readable medium of claim 17, wherein the instructions that when executed cause the at least one processor to determine the target embedding vector for each class comprise:
instructions that when executed cause the at least one processor to:
obtain training data comprising a plurality of historical embedding vectors representing historical utterances labeled with one or more classes; and
for each class of the plurality of classes, (i) determine a mean or a median of embedding vectors in that class and (ii) identify one of the historical embedding vectors closest to the mean or the median as the target embedding vector for that class.

19. The non-transitory machine-readable medium of claim 17, wherein:
the distance of the utterance embedding vector to the spatial parameter of a specified one of the plurality of classes comprises a distance of the utterance embedding vector to a threshold boundary of the specified class;
a positive value of the distance corresponds to the utterance embedding vector being inside the threshold boundary; and
a negative value of the distance corresponds to the utterance embedding vector being outside the threshold boundary.

20. The non-transitory machine-readable medium of claim 17, wherein:
the distance of the utterance embedding vector to the spatial parameter of a specified one of the plurality of classes comprises a distance of the utterance embedding vector to a class target of the specified class; and
the distance of an utterance embedding to an unhandled class comprises a smooth negative maximum of distances from the utterance embedding vector to the class targets of the plurality of classes.
